(19) United States
(12) Patent Application Publication
(10) Pub. No.: US 2009/0321677 A1
(43) Pub. Date: Dec. 31, 2009

(54) LOW MICROWAVE LOSS FERRITE MATERIAL AND MANUFACTURING PROCESS

(76) Inventors: Richard Lebourgeois, Gif Sur Yvette (FR); Ludovic Pinier, Tours (FR); Michel Pate, Nozay (FR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/722,327

(22) PCT Filed: Dec. 16, 2005
(86) PCT No.: PCT/EP2005/056844

§ 371 Date: Jun. 20, 2007

(30) Foreign Application Priority Data
Dec. 20, 2004 (FR) 0413582

(51) Int. Cl. H01F 1/34; B05D 3/02

(52) U.S. Cl. 252/62.57; 427/383.1

(57) ABSTRACT

The invention relates to a ferrite material of garnet structure based on yttrium and iron and containing copper, which makes it possible for its sintering temperature to be substantially lowered compared with the conventional ferrite materials of garnet type which satisfy the following chemical formula:

YₐRE_{b}Fe_{c}Al_{d}InₑCa_{f}Cu_{g}ZrₕVᵢCoⱼSiₖO_{12±γ}

where
RE: is a rare earth or a combination of rare earths
   and

3(a+b+c+d+e)+2(f+g+j)+4(h+k)+5i=24±2γ

1≦a≦3.5; 0≦b≦1.5; 4≦c≦5; 0≦d≦1.5; 0≦e≦0.8;

0≦f≦1; 0≦g≦0.05; 0≦i≦0.8; 0≦j≦0.5; 0≦k≦0.5.

The invention is useful in the following applications: microwave components, low-loss inductive passive components operating at frequencies of the order of gigahertz.

The invention relates to ferrite materials exhibiting low magnetic loss, particularly those suitable for producing microwave components and especially low-loss inductive passive components operating at frequencies of the order of a few gigahertz.

Such components are particularly sought after at the present time both for civil telecommunication applications and for radar applications typically operating in frequency ranges between a few gigahertz and few tens of gigahertz.

These may be inductive passive components that perform, in microwave communication systems, functions of the filter, phase shifter circulator or isolator type.

To do this, the passive components may typically comprise an element made of a ferrite in which an electromagnetic wave propagates. The ferrite material magnetized beforehand exhibits magnetic anisotropy that acts differently on the electromagnetic wave depending on whether it is polarized in one direction or another. This well-known principle of nonreciprocity is based on gyromagnetic resonance or ferromagnetic resonance.

For these applications, the performance of the component is determined by low (magnetic and dielectric) losses. Magnetic losses are directly due to the saturation magnetization which must be adjusted according to the frequency band of the application. For operations at low frequency (1 to 20 GHz), it is required to find materials with a low saturation magnetization (less than 0.2 tesla), otherwise the magnetic losses are high. For operations at higher frequency (20 to 100 GHz), it is required to find materials of higher magnetization (typically between 0.2 tesla and 0.55 tesla) in order to obtain better efficiencies, the magnetic losses being reduced.

Families of ferrite materials that are particularly suitable for these applications are ferrite materials of garnet structure, which correspond to a particular crystalline organization. The crystallographic structure of garnets is cubic. The crystallographic sites are tetrahedral (corresponding to an environment consisting of four oxygen ions), octahedral (corresponding to an environment consisting of six oxygen ions) and dodecahedral (corresponding to an environment consisting of eight oxygen ions). Let us consider the example of yttrium iron garnet (YIG) having the chemical formula:

{Y³⁺₃[Fe³⁺]₂(Fe³⁺)₃O₁₂

in which the symbols { }, [ ] and ( ) indicate the dodecahedral, octahedral and tetrahedral sites respectively and the values ³⁺ indicate the valency of the ions.

These ferrites exhibit low saturation magnetizations, enabling the low-frequency (1 to 20 GHz) magnetic losses to be limited, and low dielectric losses. Thus, yttrium/iron-based garnet ferrite of general formula: Y₃Fe₅O₁₂ makes it possible, for example, to obtain ferromagnetic resonance line widths at 10 GHz of less than 4000 A/m and dielectric loss tangents at 10 GHz of 10⁻⁴ or less.

The problem with this type of ferrite lies in the very high manufacturing temperatures, which necessarily generate high costs in developing components incorporating this type of ferrite.

This is why the invention proposes a novel family of garnet-type ferrites, the manufacture of which can be carried out at lower temperatures thanks to the presence of copper, the proportions of which have been optimized.

This is because, according to the invention, low copper contents are claimed so as to reduce the dielectric losses and the low-power magnetic losses.

In general, the ferrites are manufactured using a conventional process comprising the following steps:

a step of weighing the raw materials;

a step of mixing and grinding the raw materials;

a heat-treatment step called chamotte firing at high temperature, typically 1200° C. for the purpose of synthesizing the garnet phase in powder form;

a second step of grinding and pressing;

the very-high temperature sintering of the reground chamotte-fired powder for the purpose of densifying the ceramic, while giving it the desired shape.

Typically, with a garnet of Y₃Fe₅O₁₂ type, the sintering is carried out at a temperature between 1450° C. and 1550° C.

By adding constituents of the calcium and vanadium type, this temperature may be lowered to about 1350° C.

The ferrite materials according to the invention containing copper have a markedly lower sintering temperature, of around 1050 to 1070° C. Copper has, in particular the benefit of substituting for vanadium, which is a toxic substance. Thus, it is possible to produce ferrites at a lowered sintering temperature, while reducing the content of toxic element. Their industrial synthesis is thus easier to implement. Their low sintering temperature reduces their manufacturing cost and allows the possibility of cosintering with other types of materials like, for example, certain metals such as gold or silver-palladium alloys, or other ceramics used in the manufacture of components such as ferrites for permanent magnets or dielectrics, such as those based on alumina. For example, the ferrite according to the prior art constituting the core of a circulator is metalized with silver, very often deposited by screen printing. One or two pole pieces (which create the polarizing magnetic field) consisting of a permanent magnet of the hexaferrite type or a samarium-cobalt or neodymium-iron boron alloy, are then bonded together. This is because, according to the prior art, it is impossible to cosinter a garnet ferrite with a metal, since the minimum sintering temperatures for garnets are incompatible with the melting points of the main metals used in microelectronics (962° C. in the case of silver, 1064° C. in the case of gold, etc.).

In addition, the advantage of having lower sintering temperatures is that the solid-state diffusion reactions of the species present are minimized and the initial chemical compositions are therefore preserved, while mechanically combining the various materials. It is possible by this means to dispense with machining and assembly steps, and thus manufacture low-cost microwave components.

According to the prior art, starting from the Y₃Fe₅O₁₂ base formulation, many compositions have been optimized depending on the intended applications and any desired characteristics.

Depending on the operating frequencies and the power levels involved, the following characteristics of the material are adapted: saturation magnetization; low-power magnetic losses (ΔH or ΔHᵣₘₛ line width); high-power magnetic losses (ΔHₖ); dielectric losses; and temperature stability. Each type of application (frequency band, power level, operating temperature and temperature stability) results in a compromise between all these parameters. We mention the following substitutions that have given rise to material developments:

substitutions with aluminum (Al) which result in the following formulations: Y₃Fe₅₋₅ₓAl₅ₓO₁₂, x varying from 0 to 0.3. They make it possible to reduce the saturation magnetization of the ferrite without increasing the magnetic losses, hence adapting the material to the operating frequency;

substitutions with gadolinium (Gd) which result in the following formulations: Y_{3-3y}Fe₅Gd_{3y}O₁₂, y varying from 0 to 0.5. They make it possible to reduce the saturation magnetization of the ferrite without reducing the Curie temperature. The high-power behavior (ΔHₖ) is also improved;

mixed substitutions with aluminum (Al) and gadolinium (Gd), which result in the following formulations: Y_{3-3y}Gd_{3y}Fe₅₋₅ₓAl₅ₓO₁₂, x varying from 0 to 0.3 and y varying from 0 to 0.5. In this way, the combined effects described above are obtained;

substitutions with indium (In) or with calcium-zirconium (Ca—Zr) which result in the following formulations: Y₃Fe_{5-z}In_{z}O₁₂ or Y_{3-z}Ca_{z}Fe_{5-z}Zr_{z}O₁₂, z varying from 0 to 0.6. In this way, the saturation magnetization is increased;

substitutions with calcium-indium-vanadium which result in the following formulations: Y₃₋₂ₓCa₂ₓFe_{5-x-y}In_{y}V_{z}O₁₂ z varying from 0 to 0.5. They make it possible to increase the saturation magnetization and to reduce the low-power magnetic losses;

substitutions with cobalt (Co) which is combined with silicon or with germanium, thereby giving the following formulations: Y₃Fe₅₋₂ᵤMeᵤCoᵤO₁₂, Me being Si or Ge and u varying from 0 to 0.2. They allow operation at high power to the detriment of the low-power performance (increase in ΔH);

substitutions with gadolinium and/or magnetic rare earth ions, such as dysprosium or holmium, the formulations of which are the following: Y_{3-3x-3z}Fe_{5-5y}Gd₃ₓMe_{3z}Al_{5y}O₁₂. They also allow high-power operation but, for low substitution levels, the low-level losses are also improved.

Another advantage of the invention lies in the fact that in particular for applications at the frequencies used in the telecommunication field, the ferrite must have a relatively high molar concentration of yttrium and/or gadolinium. Using a copper-substituted ferrite, advantageous properties are obtained by reducing the yttrium and/or gadolinium contents, since copper substitutes for these elements in the ferrite according to the invention.

Another advantage of the invention is that copper makes it possible to dispense with vanadium, which is a toxic element.

Thus, more precisely, the subject of the invention is a ferrite material based on yttrium and iron characterized in that it satisfies the following chemical formula:

YₐRE_{b}Fe_{c}Al_{d}InₑCa_{f}Cu_{g}ZrₕVᵢCoⱼSiₖO_{12±γ}

where

RE: is a rare earth or a combination of rare earths

and

3(a+b+c+d+e)+2(f+g+j)+4(h+k)+5i=24±2γ

1≦a≦3.5; 0≦b≦1.5; 4≦c≦5; 0≦d≦1.5; 0≦e≦0.8;

0≦f≦1; 0≦g≦0.05; 0≦i≦0.8; 0≦j≦0.5; 0≦k≦0.5.

Advantageously, the rare earths may be of the gadolinium (Gd), dysprosium (Dy) or holmium (Ho) type.

The subject of the invention is also a ferrite-based composite, characterized in that it comprises a material according to the invention, cosintered with one or more materials of the metal type or dielectric type or ferroelectric type.

The subject of the invention is also a magnetic component, comprising a magnetic core made of a ferrite material according to the invention and a magnetic component, characterized in that it includes a microwave circulator or phase shifter made of a ferrite material, according to the invention, which can operate in a frequency range from about 0.5 gigahertz to about 20 gigahertz.

Finally, the subject of the invention is a process for manufacturing a ferrite material according to the invention, characterized in that it comprises the following steps:
weighing of the raw materials of oxide or carbonate type in order to obtain the composition of the ferrite material;
mixing and first grinding of the raw materials;
chamotte firing at a temperature between about 800° C. and 1050° C., in one or more steps;
second grinding of the powder obtained, followed by pressing; and
sintering of said reground powder at a temperature between about 900° C. and 1100° C.

The subject of the invention is also a process for manufacturing the material, characterized in that it comprises the following steps:
weighing of the raw materials of oxide or carbonate type in order to obtain the composition of the ferrite material;
mixing and first grinding of the raw materials;
chamotte firing at a temperature between about 800° C. and 1100° C. in one or more steps;
second grinding of the powder obtained;
mixing of said reground powder with organic substances (binders, deflocculants, surfactants, etc.) in order to produce a slurry;
thick-film deposition of this slurry by casting or screen printing;
production of a multilayer structure consisting of a stack comprising layers of hard ferrite (permanent magnet), of metal (silver, silver-palladium, gold) and of ferrite as claimed in claim 3; and
sintering of said multilayer structure at a temperature between about 850° C. and 1100° C.

The hard ferrite may advantageously be of the hexaferrite type.

Advantageously, the first grinding may be carried out in a wet medium.

The invention will be better understood and other advantages will appear upon reading the following description.

In general, the ferrite material according to the invention satisfies the chemical formula:

YₐRE_{b}Fe_{c}Al_{d}InₑCa_{f}Cu_{g}ZrₕVᵢCoⱼSiₖO_{12±γ}

where:

RE: is a rare earth or a combination of rare earths

and

3(a+b+c+d+e)+2(f+g+j)+4(h+k)+5i=24±2γ

1≦a≦3.5; 0≦b≦1.5; 4≦c≦5; 0≦d≦1.5; 0≦e≦0.8;

0≦f≦1; 0≦g≦0.05; 0≦i≦0.8; 0≦j≦0.5; 0≦k≦0.5.

In general, the ferrite material is produced according to the steps described below:

Step 1

All the raw materials of oxide and/or carbonate type are weighed so as to produce the appropriate garnet ferrite.

Step 2

All the raw materials are mixed/ground for example using a ball mill (a sealed container filled with stainless steel balls or any other hard non-contaminating material) or by an attrition mill (a rotary system filled with contacting balls that grind the powder by shear) so as to form a first powder.

Step 3

The first powder is heat treated at a temperature between about 800° C. and 1100° C., preferably in air, in nitrogen or in oxygen, one or more times.

This step corresponds to the conventional chamotte firing or calcination step for the manufacture of a ferrite material, the purpose of which is to partly form the desired crystalline phase.

Step 4

The calcined powder is ground again under conditions similar to those of step 2.

Step 5

The reground powder is then pressed, by isostatic or axial pressing with pressures of the order of 1000 to 2000 bar in order to promote densification during sintering.

Step 6

The reground and pressed powder is then heated to high temperature. The purpose of this “sintering” operation is to complete the formation of the crystalline garnet phase and to densify the ceramic.

It is carried out at temperatures between about 900° C. and 1150° C. and preferably in air or in oxygen.

### EXEMPLARY EMBODIMENTS

### Example 1

To demonstrate the benefit of the invention, five formulations were synthesized using the same operating method:

Y₃Fe₅O₁₂ (reference A)

YₐCu_{g}Fe₅O₁₂; a=2.98 and g=0.02 (reference B)

YₐCu_{g}Fe₅O₁₂; a=2.97 and g=0.03 (reference C)

YₐCu_{g}Fe₅O₁₂; a=2.96 and g=0.04 (reference D)

YₐCu_{g}Fe₅O₁₂; a=2.951 and g=0.049 (reference E)

The raw materials were industrial oxides, CuO, Y₂O₃ and Fe₂O₃.

The grinding operations were carried out by attrition for 30 minutes at a speed of 500 rpm. The grinding balls were made of ceria-doped zirconia and the ball mill jar was made of stainless steel.

The chamotte firing was carried out at 1050° C. for the formulations containing copper and at 1200° C. for formulation A containing no copper.

X-ray analysis indicated that the garnet crystalline phase had been obtained for the five formulations.

The sintering was carried out at 1070° C. or 1080° C. in oxygen in the case of the formulations containing copper and at 1480° C. for that containing no copper, i.e. a difference of 410° C.

The measured densities after sintering are given below:

| | Sintering at | Sintering at | Sintering at |
|---|---|---|---|
| Reference | 1070° C. | 1080° C. | 1480° C. |
| A | | | 5.04 g/cm³ |
| B | 5.05 g/cm³ | 5.11 g/cm³ | |
| C | 5.10 g/cm³ | 5.14 g/cm³ | |
| D | 5.12 g/cm³ | 5.12 g/cm³ | |
| E | 5.11 g/cm³ | 5.11 g/cm³ | |

Higher densities are obtained with the formulations containing copper, despite the sintering temperatures being 350 or 360° C. lower.

The saturation magnetic moments per gram are, respectively:

| | Sintering at | Sintering at | Sintering at |
|---|---|---|---|
| Reference | 1070° C. | 1080° C. | 1480° C. |
| A | | | 28.7 emu/g |
| B | 27.5 emu/g | 27.6 emu/g | |
| C | 28.4 emu/g | 28.1 emu/g | |
| D | 28.9 emu/g | 28.0 emu/g | |
| E | 28.2 emu/g | 27.6 emu/g | |

(emu: the electromagnetic unit per gram)

Comparison of the Low-Power Magnetic Losses Between Ferrites Aa, B, C, D and E:

The measured magnetic losses such as the width (ΔH) of the gyromagnetic resonance line at 10 GHz are, respectively:

| | Sintering at | Sintering at | Sintering at |
|---|---|---|---|
| Reference | 1070° C. | 1080° C. | 1480° C. |
| A | | | ΔH = 40 Oe ± 10 Oe |
| B | ΔH = 70 Oe ± 10 Oe | ΔH = 70 Oe ± 10 Oe | |
| C | | ΔH = 60 Oe ± 10 Oe | |
| D | | ΔH = 80 Oe ± 10 Oe | |
| E | ΔH = 60 Oe ± 10 Oe | ΔH = 70 Oe ± 10 Oe | |

The magnetic losses close to resonance are higher in the case of the copper-containing specimens, but are largely acceptable for the microwave applications envisioned.

| | Sintering at | Sintering at |
|---|---|---|
| Reference | 1070° C. | 1480° C. |
| A | | ΔHᵣₘₛ = 8 ± 1 Oe |
| B | ΔHᵣₘₛ = 11 ± 1 Oe | |
| C | ΔHᵣₘₛ = 17 ± 2 Oe | |
| D | ΔHᵣₘₛ = 25 ± 3 Oe | |
| E | | |

The magnetic losses far from resonance are lower in the case of the specimens containing little copper. They are compatible with the envisioned microwave applications, such as, for example microwave circulators or isolators.

The high-frequency (10 GHz) dielectric losses, tan δ₆₈, are:

| | Sintering at | Sintering at |
|---|---|---|
| Reference | 1070° C. | 1480° C. |
| A | | tanδ_{ε} = 2 × 10⁻⁴ |
| B | tanδ_{ε} = 5.5 × 10⁻⁴ | |
| C | tanδ_{ε} = 3 × 10⁻⁴ | |
| D | tanδ_{ε} = 3.5 × 10⁻⁴ | |
| E | tanδ_{ε} = 2.5 × 10⁻³ | |

The dielectric losses are lower in the case of the specimens containing little copper. They are compatible with the envisioned microwave applications such as, for example, microwave circulators or isolators.

1. A ferrite material of garnet structure based on yttrium and iron satisfying the following chemical formula:
YₐRE_{b}Fe_{c}Al_{d}InₑCa_{f}Cu_{g}ZrₕVᵢCoⱼSiₖO_{12±γ}
wherein:
RE: is a rare earth or a combination of rare earths
and
3(a+b+c+d+e)+2(f+g+j)+4(h+k)+5i=24±2γ
1≦a≦3.5; 0≦b≦1.5; 4≦c≦5; 0≦d≦1.5; 0≦e≦0.8;
0≦f≦1; 0≦g≦0.05; 0≦i≦0.8; 0≦j≦0.5; 0≦k≦0.5.

2. The ferrite material as claimed in claim 1, wherein the rare earth or earths are of the Gd, Dy or Ho type.

3. A ferrite-based composite, comprising a ferrite material as claimed in claim 1, cosintered with one or more materials of the metal type or dielectric type or ferroelectric type.

4. A magnetic component, comprising a magnetic core made of a ferrite material as claimed in claim 1.

5. A magnetic component, including a microwave circulator or phase shifter made of a ferrite material as claimed in claim 1.

6. The magnetic component as claimed claim 4, operating in a frequency range from about 0.5 gigahertz to about 20 gigahertz.

7. A process for manufacturing a material as claimed claim 1, characterized in that it comprises the following steps:
weighing of the raw materials of oxide or carbonate type in order to obtain the composition of the ferrite materials;
mixing and first grinding of the raw material;
chamotte firing at a temperature between about 800° C. and 1050° C.;
second grinding of the powder obtained, followed by pressing; and
sintering of said reground powder at a temperature between about 900° C. and 1100° C.

8. The manufacturing process as claimed in claim 7, wherein the first grinding is carried out in a wet medium.

9. The manufacturing process as claimed claim 7, wherein the sintering of the reground powder is carried out in air or in oxygen.

10. The manufacturing process as claimed in claim 7, wherein the grinding operations are carried out in a ball mill and/or an attrition mill.

11. A process for manufacturing the material as claimed in claim 3, comprising the following steps:
weighing of the raw materials of oxide or carbonate type in order to obtain the composition of the ferrite material;
mixing and first grinding of the raw materials;
chamotte firing at a temperature between about 800° C. and 1100° C.;
second grinding of the powder obtained, followed by pressing;
mixing of said reground powder with organic substances (binders, deflocculants, surfactants, etc.) in order to produce a slurry;
thick-film deposition of this slurry by casting or screen printing;
production of a multilayer structure consisting of a stack comprising layers of hard ferrite (permanent magnet), of metal (silver, silver-palladium, gold) and of ferrite as claimed in claim 3; and
sintering of said multilayer structure at a temperature between about 850° C. and 1100° C.

12. The manufacturing process as claimed in claim 11, wherein the hard ferrite is of the hexaferrite type.

13. A ferrite-based composite comprising a ferrite material as claimed in claim 2, cosintered with one or more materials of the metal type or dielectric type or ferroelectric type.

14. The magnetic component, comprising a magnetic core made of a ferrite material as claimed in claim 4, wherein the rare earth or earths are of the Gd, Dy or Ho type.

15. The magnetic component, comprising a magnetic core made of a ferrite material as claimed in claim 4, cosintered with one or more materials of the metal type or dielectric type or ferroelectric type.

16. The magnetic component, including a microwave circulator or phase shifter made of a ferrite material as claimed in claim 5, wherein the rare earth or earths are of the Gd, Dy or Ho type.

17. The magnetic component, including a microwave circulator or phase shifter made of a ferrite material as claimed in claim 5, cosintered with one or more materials of the metal type or dielectric type or ferroelectric type.

18. The process for manufacturing a material as claimed claim 7, characterized in that it comprises the following steps:
weighing of the raw materials of oxide or carbonate type in order to obtain the composition of the ferrite materials;
mixing and first grinding of the raw material;
chamotte firing at a temperature between about 800° C. and 1050° C.;
second grinding of the powder obtained, followed by pressing; and sintering of said reground powder at a temperature between about 900° C. and 1100° C.
wherein the rare earth or earths are of the Gd, Dy or Ho type.

19. The manufacturing process as claimed in claim 8, wherein the sintering of the reground powder is carried out in air or in oxygen.

20. The manufacturing process as claimed in claim 8, wherein the grinding operations are carried out in a ball mill and/or an attrition mill.

21. The manufacturing process as claimed claim 9, wherein the grinding operations are carried out in a ball mill and/or an attrition mill.
